(19) United States
(12) Patent Application Publication
(10) Pub. No.: US 2012/0143894 A1
(43) Pub. Date: Jun. 7, 2012

(54) Acquisition of Item Counts from Hosted Web Services

(75) Inventors: Sean Ferguson, Redmond, WA (US); Zainal Arifin, Redmond, WA (US); Yingtao Dong, Redmond, WA (US); Nanda Raghunathan, Redmond, WA (US); Thottam Sriram, Redmond, WA (US); Naresh Sundaram, Redmond, WA (US)

(73) Assignee: MICROSOFT CORPORATION, Redmond, WA (US)

(21) Appl. No.: 12/958,660

(22) Filed: Dec. 2, 2010

(51) Int. Cl. G06F 17/30; G06F 15/16

(52) U.S. Cl. 707/769; 707/E17.014

(57) ABSTRACT

A web Application Programming Interface (API) server receives a statistics request from a client. The statistics request is a request to invoke an item counting method defined in an API provided by the web API server. The statistics request specifies a keyword string and multiple target data repositories. As a response to the statistics request, the web API server sends a statistics response to the client. The statistics response specifies an item count that indicates how many relevant items are in the target data repositories. Each of the relevant items is associated with at least one keyword in the keyword string.

### BACKGROUND

In recent years, hosted web services have been growing in popularity. In the hosted web services model, a service provider manages the hardware and software needed to provide a service to a consumer via a communications network, such as the Internet. Service providers can provide a wide variety of services to consumers according to this model. For example, a service provider can manage hardware and software needed to provide hosted email services, document creation and storage services, unified communications services, and other types of services to consumers.

However, the use of hosted web services has made electronic discovery (“e-discovery”) during litigation more difficult. When performing e-discovery, a searcher attempts to identify electronically-stored items relevant to criteria provided by a party to a lawsuit. Searchers execute one or more searches to identify relevant items. Because modern companies can retain large numbers of electronically-stored items, such searches can take considerable amounts of time to complete. The use of a hosted web service to electronically store items can further increase the amount of time for such searches to complete because of communication delays between the searcher and the hosted web service and communication delays between computing devices that provide the host web service.

### SUMMARY

A statistics request is sent to a web Application Programming Interface (API) server. The statistics request requests invocation of an item counting method defined by an API provided by the web API server. The statistics request specifies a query. The query specifies a keyword string and multiple data repositories. The keyword string comprises one or more keywords. Subsequently, a statistics response is received from the web API server as a response to the statistics request. The statistics response specifies an item count. The item count indicates how many relevant items are in the target data repositories, each of the relevant items associated with at least one of the keywords in the keyword string.

In some instances, knowing how many relevant items are in the target data repository can help a searcher refine the keyword string of the query in order to reduce the number of items that are irrelevant to a discovery request. Reducing the number of items that are irrelevant to the discovery request can reduce the time needed to complete a search. As described herein, the item count can be obtained using only a single statistics request. In some instances, use of a single statistics request to obtain the item count is faster than using multiple statistics requests to obtain the item count.

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

### BRIEF DESCRIPTION OF THE DRAWINGS

FIG. 1 is a block diagram illustrating an example system.

FIG. 2 is a block diagram illustrating example details of a server system.

FIG. 3 is a flowchart illustrating an example operation performed by a web API server.

FIG. 4 is a flowchart illustrating an example operation performed by the web API server to generate an item count for a query.

FIG. 5 is an example screen illustration of a keyword statistics request page.

FIG. 6 is an example screen illustration of a keyword statistics review page.

FIG. 7 is a block diagram illustrating an example computing device.

### DETAILED DESCRIPTION

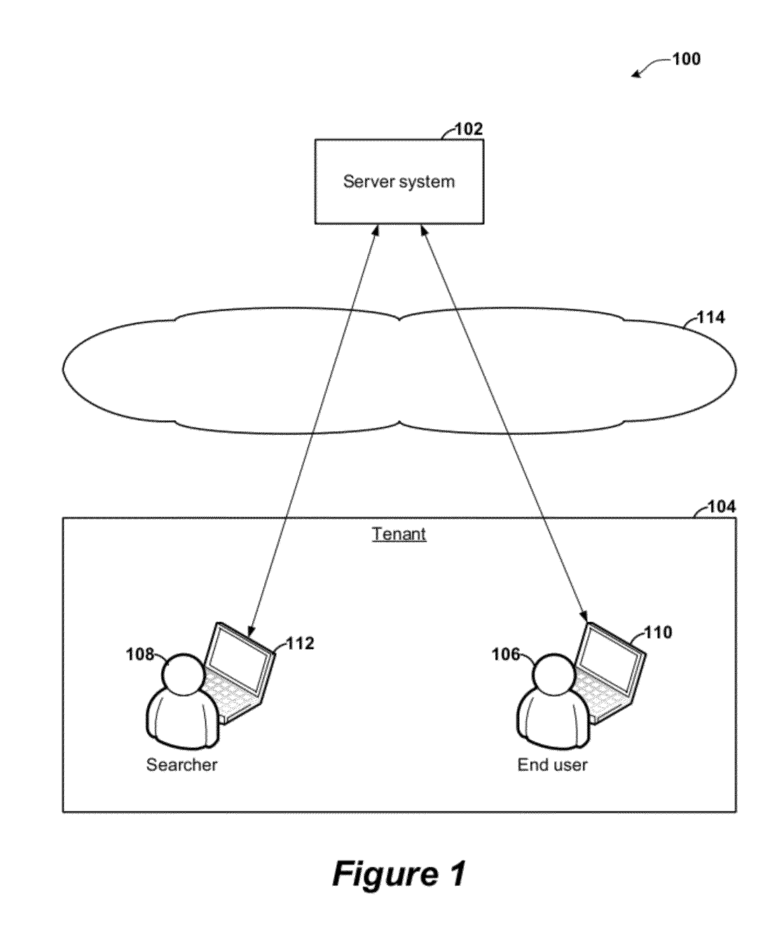

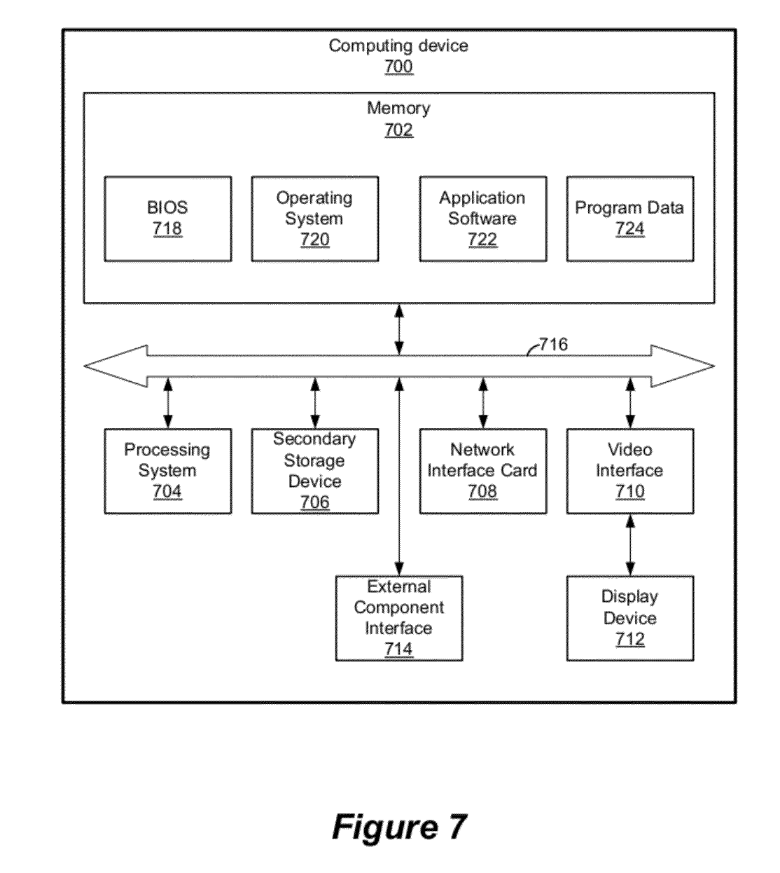

FIG. 1 is a block diagram illustrating an example system 100. As illustrated in example of FIG. 1, the system 100 comprises a server system 102 and a tenant 104. The server system 102 comprises one or more computing devices. In some embodiments, the server system 102 comprises one or more computing devices of a type described below with regard to the example of FIG. 7. The tenant 104 is an entity, such as a business organization, a governmental organization, a non-profit organization, or another type of entity.

The tenant 104 is associated with an end user 106 and a searcher 108. The end user 106 and the searcher 108 are people. The end user 106 uses a client device 110. The searcher 108 uses a client device 112. In some embodiments, the client device 110 and/or the client device 112 comprise one or more computing devices of the type described below with regard to the example of FIG. 7. The end user 106 and the searcher 108 can, in various embodiments, be associated with the tenant 104 in various ways. For example, the end user 106 and/or the searcher 108 can be employees of the tenant 104, owners of the tenant 104, contractors for the tenant 104, clients of the tenant 104, users of a service provided by the tenant 104, agents of the tenant 104, trustees of the tenant 104, or otherwise be associated with the tenant 104. It should be appreciated that the tenant 104 can be associated with individuals in addition to the end user 106 and the searcher 108.

The system 100 comprises a network 114. The network 114 enables the server system 102 to communicate with the client device 110 and the client device 112. In various embodiments, the network 114 can comprise various types of communications networks. For example, the network 114 can comprise a wide area network, such as the Internet. In another example, the network 114 can comprise a local area network. The network 114 can comprise wired and/or wireless communications links.

The server system 102 provides a hosted web service to the tenant 104. The hosted web service electronically stores data items for the tenant 104. The data items are stored by the hosted web service in one or more data repositories. Each of the data repositories comprises one or more data structures for storage and retrieval of data items.

In various embodiments, the server system 102 can provide various types of hosted web services to the tenant 104. For example, the server system 102 can provide a hosted email service to the tenant 104. The hosted email service can receive email messages addressed to accounts associated with the tenant 104 and can enable users associated with the tenant 104 to retrieve and view such email messages. Furthermore, in this example, the hosted email service can send email messages from accounts associated with the tenant 104. The hosted email service stores email messages in mailboxes. A mailbox is a type of data repository that represents a storage area for email messages. In this example, the end user 106 can use a web browser or other application operating on the client device 110 to check and send email messages using the hosted email service provided by the server system 102.

Other examples of hosted web services that the server system 102 can provide to the tenant 104 include, but are not limited to, hosted calendaring services, hosted contact management services, hosted task management services, hosted document management services, and other types of hosted web services. For ease of explanation, the remainder of this patent document describes a hosted email service. Nevertheless, it should be appreciated that at least some following discussion of related to the hosted email service can apply generally to other hosted web services. For example, at least some of the following discussion of email messages and mailboxes can apply generically to data items and data repositories.

The server system 102 is operated by a hosting provider. The hosting provider is entity other than the tenant 104. For example, the tenant 104 can be one corporation and the hosting provider can be another corporation. This can be an advantageous arrangement for the tenant 104 for various reasons. For example, the tenant 104 may not have the expertise to build and/or operate a server that provides the web service provided by the server system 102. In this example, the hosting provider has such expertise. Furthermore, the server system 102 can provide the web service to entities in addition to the tenant 104. For example, the server system 102 can provide the hosted web service to the tenant 104 and several other tenants, such as companies or agencies. Because the same set of hardware and software (i.e., the server system 102) provides the web service to multiple tenants, the hosting provider may incur less total costs than if each of the tenants separately implemented servers that provide the web service. Accordingly, the hosting provider can pass along the resulting savings to the tenants. In instances where the server system 102 provides the web service to multiple tenants, the server system 102 can appear to each of the tenants as if the server system 102 provides the hosted web service exclusively to them. In other words, it can appear to the tenant 104 as if the server system 102 is providing the hosted web service exclusively to the tenant 104 when in fact the server system 102 is providing the hosted web service to one or more tenants in addition to the tenant 104.

In some embodiments, the server system 102 is not physically located at a premises of the tenant 104. Rather, the server system 102 can be physically located at one or more premises of the hosting provider. For example, the server system 102 can be physically located at a building owned or occupied by the hosting provider.

In American law, discovery refers to the compulsory disclosure of documents or other evidence by a party in a lawsuit. Electronic discovery (e-discovery) refers to discovery of information that is stored in electronic format. Because some entities electronically store large numbers of email messages, it can be a complex, costly, and time consuming process to identify relevant email messages in e-discovery. The challenges of e-discovery can be greater when the email messages are not stored on computing devices owned and operated by the party subject to e-discovery requests (i.e., the tenant 104), such as when the email messages are created and stored as part of the hosted email service provided by the server system 102. Some of these challenges arise because the email messages may need to be transferred from the server system 102 to the tenant 104 via the network 114. Transferring large numbers of email messages across the network 114 can be time consuming and potentially expensive for both the tenant 104 and the hosting provider.

In the example of FIG. 1, the searcher 108 is responsible for processing an e-discovery request on behalf of the tenant 104. To process the e-discovery request, the searcher 108 needs to identify relevant email messages within one or more target mailboxes. For example, the searcher 108 may need to identify in the mailboxes of company executives email messages regarding the profits made by the tenant 104 during a given year.

The server system 102 provides a control panel to help the searcher 108 identify relevant email messages in the target mailboxes. In some embodiments, the control panel comprises webpages that enable the searcher 108 input a query. The query specifies a keyword string and the target mailboxes. The query can correspond to the criteria of the e-discovery request. The keyword string comprises one or more keywords. For example, the query can comprise the following keyword string: “patent AND (litigation OR lawsuit).” In this example, “patent,” “litigation,” and “lawsuit” are keywords. Furthermore, in this example, an email message satisfies the keyword string if the email message is associated with the keyword “patent,” and is associated with either the keyword “litigation” or the keyword “lawsuit.” An email message satisfies a query when the email message is in one of the target mailboxes of the query and satisfies the keyword string of the query. When the searcher 108 inputs the query, the server system 102 can transmit copies of the email messages that satisfy the query.

However, in a system where the searcher 108 uses a query to download email messages, proper selection of keywords in the query can be important. To help the searcher 108 select keywords to include in the query, the control panel enables the searcher 108 to obtain one or more item counts for the query without downloading any email messages. An item count for a query indicates how many relevant email messages are in the target mailboxes of the query. Different email messages are considered to be “relevant” in different item counts for the query. For example, an item count for the query may require that an email message satisfy the query's keyword string in order to be considered relevant. In another example, an item count for the query may require that an email message be associated with a particular one of the keywords in the query's keyword string in order to be considered relevant. In some embodiments, an email message is associated with a keyword when the email message contains the keyword and/or metadata for the email message contains the keyword.

The searcher 108 can use the item counts for the query to determine whether he or she has selected appropriate keywords in the query. For example, if an item count is higher than expected, the query's keywords may not be sufficiently descriptive of the desired email messages. Consequently, in this example, the set of email messages returned by the query could return a large number of email messages that are not relevant to the e-discovery request. On the other hand, if an item count is lower than expected, the set of email messages returned by the query may not include email messages that are relevant to the e-discovery request. Thus, by obtaining item counts for different queries, the searcher 108 can refine the query's keyword string without downloading the email messages to the client device 110.

It can be advantageous for the server system 102 to quickly determine item counts for a query. In this way, the searcher 108 can quickly select and refine the query's keywords. As described in detail below, the server system 102 provides an application programming interface (API) that includes an item counting method. The server system 102 invokes the item counting method in response to a statistics request. The statistics request specifies a query. The query specifies a keyword string and a set of target mailboxes. In response to a single statistics request, the item counting method returns a statistics response that specifies at least one item count. For example, the statistics response can specify an item count that indicates how many email messages satisfy the query. Because the item counting method returns at least one item count for a query in response to a single statistics request, the server system 102 may be able to provide item counts to the searcher 108 quicker than if multiple requests were needed.

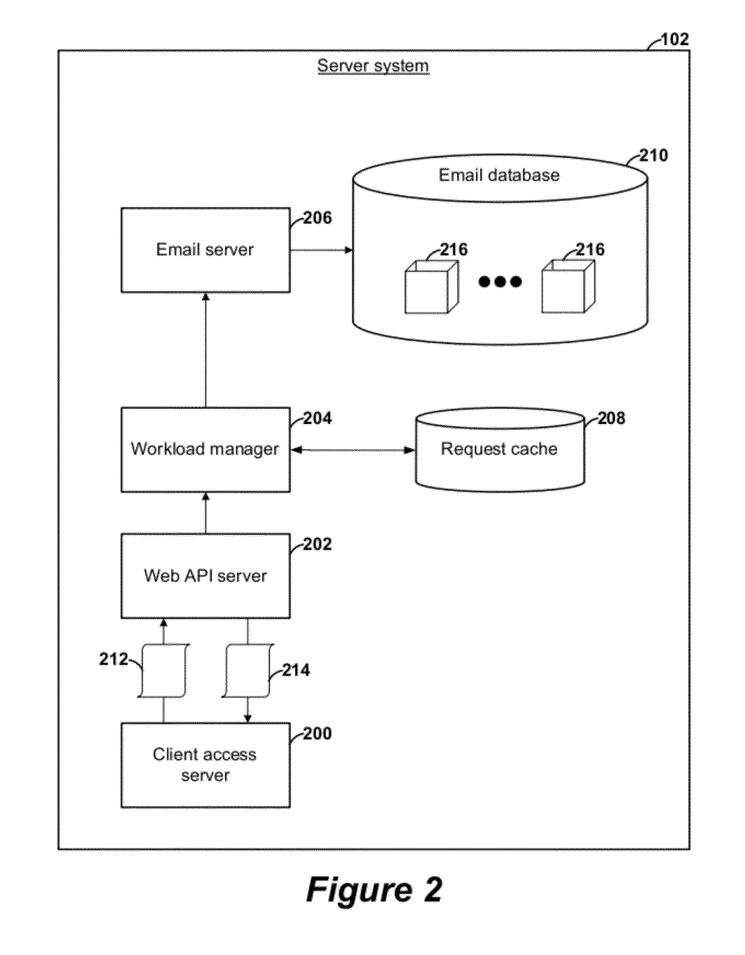

FIG. 2 is a block diagram illustrating example details of the server system 102. As mentioned briefly above, the server system 102 comprises one or more computing devices. For example, the server system 102 can comprise one or more blade server devices, standalone server devices, personal computers, routers, hubs, switches, bridges, firewall devices, intrusion detection devices, mainframe computers, network-attached storage devices, and other types of computing devices.

In embodiments where the server system 102 comprises multiple computing devices, the server system 102 can comprise one or more communications networks that facilitate communication among the computing devices. For example, the server system 102 can comprise a local or wide area network that facilitates communication among the computing devices. In another example, the server system 102 can comprise one or more direct communication links between the computing devices. Furthermore, in embodiments where the server system 102 comprises multiple computing devices, the computing devices can be installed at geographically distributed locations. Alternately, in embodiments where the server system 102 comprises multiple computing devices, the computing devices can be installed at a single geographic location, such as a server farm or an office.

As illustrated in the example of FIG. 2, the server system 102 provides a client access server 200, a web API server 202, a workload manager 204, and an email server 206. In various embodiments, the client access server 200, the web API server 202, the workload manager 204, and the email server 206 can be implemented in various ways. For example, the client access server 200, the web API server 202, the workload manager 204, and the email server 206 can be implemented as application software, utility software, or another type of software executed by one or more processing units of computing devices in the server system 102. Furthermore, in some embodiments, the client access server 200, the web API server 202, the workload manager 204 and the email server 206 can be implemented using one or more application-specific integrated circuits (ASICs).

In addition, the server system 102 comprises a request cache 208 and an email database 210. As described below, the request cache 208 temporarily stores requests received by the workload manager 204. The email database 210 stores a set of mailboxes 216. In various embodiments, the request cache 208 and the email database 210 can be implemented in various ways. For example, the request cache 208 and/or the email database 210 can be implemented as one or more relational databases, flat files, associative database, object-oriented database, or other types of structures for storing and retrieving data.

The client access server 200 hosts a control panel website. The control panel website is a set of webpages that enable people associated with the tenant 104 to perform administration tasks with regard to the hosted email service provided to the tenant 104. For example, an agent of the tenant 104 can use the control panel website to configure the hosted email service to add or remove mailboxes, configure the hosted email service to communicate with a key distribution server operated by the tenant 104, or perform other administration tasks with regard to the hosted email service.

The control panel website includes a keyword statistics request page. The keyword statistics request page enables the searcher 108 to submit a query that specifies a keyword string and a set of target mailboxes. The searcher 108 selects the target mailboxes from among the mailboxes 216 stored in the email database 210. The control panel website also includes a keyword statistics response page that enables the searcher 108 to view item counts for particular queries.

Furthermore, in some embodiments, the keyword statistics request page enables the searcher 108 to submit one or more scope parameters. The scope parameters provide further limits on which email messages are considered to be relevant. For example, the keyword statistics request pages can enable the searcher 108 to submit a language parameter that limits the email messages considered to be relevant to those email messages in a particular language, such as English or Spanish. In another example, the keyword statistics request page can enable the searcher 108 to submit sender and/or recipient parameters that limit the relevant email messages to those sent or received by particular senders. In yet another example, the keyword statistics request page can enable the searcher 108 to submit a starting date parameter and/or an ending date parameter that limit the relevant email messages to those sent after a particular date and/or those sent before a particular date. Other scope parameters can specify types of messages, whether to include deleted email messages, whether to include archived email messages, whether to include unsearchable email messages, and so on.

The web API server 202 provides a web API service. The web API service enables clients to remotely invoke methods in an API. The API includes the item counting method. When the searcher 108 submits a query to the client access server 200, the client access server 200 provides a statistics request message 212 to the web API server 202. The statistics request message 212 is a request to invoke the item counting method of the API. The statistics request message 212 specifies the query. When the web API server 202 receives the statistics request message 212, the web API server 202 invokes the item counting method.

In various embodiments, the statistics request message 212 is formatted in various ways. For example, in some embodiments, the statistics request message 212 is formatted as a SOAP request. In this example, the statistics request message 212 conforms to the following schema:

<xs:complexType name=“FindMailboxStatisticsByKeywordsType”>

<xs:annotation>

<xs:documentation>

Request type for the FindMailboxStatisticsByKeywords web method.

</xs:documentation>

</xs:annotation>
<xs:complexContent>

<xs:extension base=“m:BaseRequestType”>

<xs:sequence>

<xs:element name=“Mailboxes” type=“t:ArrayOfUserMailboxesType”

minOccurs=“1”/>

<xs:element name=“Keywords” type=“t:ArrayOfStringsType” minOccurs=“1”/>
<xs:element name=“Language” type=“xs:string” minOccurs=“0”/>
<xs:element name=“Senders” type=“t:ArrayOfSmtpAddressType” minOccurs=“0”/>
<xs:element name=“Recipients” type=“t:ArrayOfSmtpAddressType”

minOccurs=“0”/>

<xs:element name=“FromDate” type=“xs:dateTime” minOccurs=“0”/>
<xs:element name=“ToDate” type=“xs:dateTime” minOccurs=“0”/>
<xs:element name=“MessageTypes” type=“t:ArrayOfSearchItemKindsType”

minOccurs=“0”/>

<xs:element name=“SearchDumpster” type=“xs:boolean” minOccurs=“0”/>
<xs:element name=“IncludePersonalArchive” type=“xs:boolean”

minOccurs=“0”/>

<xs:element name=“IncludeUnsearchableItems” type=“xs:boolean”

minOccurs=“0”/>

</xs:sequence>

</xs:extension>

</xs:complexContent>

</xs:complexType>
<xs:element name=“FindMailboxStatisticsByKeywords”
type=“m:FindMailboxStatisticsByKeywordsType”/>

In this example, the statistics request message 212 comprises a “FindMailboxStatisticsByKeywordType” element. The “FindMailboxStatisticsByKeywordType” element includes a “keywords” element. The “keywords” element specifies the query's keyword string. In addition, the “FindMailboxStatisticsByKeywordType” element can include a “language” element, a “senders” element, a “recipients” element, a “FromDate” element, a “ToDate” element, a “MessageTypes” element, a “SearchDumpster” element, an “IncludePersonalArchive” element, and an “IncludeUnsearchableItems” element. These elements provide scope parameters. Furthermore, the “FindMailboxStatisticsByKeywordType” element includes a “Mailboxes” element of type “ArrayOfUserMailboxesType.” The “Mailboxes” element specifies the set of target mailboxes.

In this example, an element of type “ArrayOfUserMailboxesType” comprises a set of one or more “UserMailboxType” elements. Elements of type “ArrayOfUserMailboxesType” conform to the following schema:

<xs:complexType name=“ArrayOfUserMailboxesType”>

<xs:annotation>

<xs:documentation>

Array of user mailbox.

</xs:documentation>

</xs:annotation>
<xs:sequence>

<xs:element name=“UserMailbox” type=“t:UserMailboxType”

minOccurs =“1” maxOccurs=“unbounded”/>

</xs:sequence>

</xs:complexType>

Furthermore, in this example, elements of type “UserMailboxType” specify an identifier for a target mailbox and whether the target mailbox is an archive mailbox. An archive mailbox is a mailbox that is stored in a compressed format for long-term storage with infrequent access. Elements of type “UserMailboxType” conform to the following schema:

<xs:complexType name=“UserMailboxType”>

<xs:annotation>

<xs:documentation>

User mailbox.

</xs:documentation>

</xs:annotation>
<xs:attribute name=“Id” type=“xs:string” use=“required”/>
<xs:attribute name=“IsArchive” type=“xs:boolean” use=“required”/>

</xs:complexType>

In this example, elements of type “ArrayOfSearchItemKindsType” conform to the following schema:

<xs:complexType name=“ArrayOfSearchItemKindsType”>

<xs:annotation>

<xs:documentation>

Array of search item kind enum.

</xs:documentation>

</xs:annotation>
<xs:sequence>

<xs:element name=“SearchItemKind”
type=“t:SearchItemKindType” minOccurs =“1”/>

</xs:sequence>

</xs:complexType>

Furthermore, in this example, the “SearchItemKind” elements specify types of items regarding which the searcher 108 wants keyword statistics. Elements of type “SearchItemKindType” conform to the following schema:

<xs:simpleType name=“SearchItemKindType”>

<xs:restriction base=“xs:string”>

<xs:enumeration value=“Email” />
<xs:enumeration value=“Meetings” />
<xs:enumeration value=“Tasks” />
<xs:enumeration value=“Notes” />
<xs:enumeration value=“Docs” />

<xs:enumeration value=“Journals” />

<xs:enumeration value=“Contacts” />
<xs:enumeration value=“Im” />
<xs:enumeration value=“Voicemail” />
<xs:enumeration value=“Faxes” />
<xs:enumeration value=“Posts” />

<xs:enumeration value=“Rssfeeds” />

</xs:restriction>

</xs:simpleType>

When invoked, the item counting method sends a mailbox search request to the workload manager 204. The mailbox search request specifies the query. The item counting method sends such mailbox search requests for each of the target mailboxes. For example, if there are six target mailboxes, the item counting method sends six mailbox search requests to the workload manager 204.

The workload manager 204 manages the workload placed on the email server 206. When the workload manager 204 receives a mailbox search request, the workload manager 204 determines whether the client device 112 has exceeded its request budget. The request budget provides a limit on the amount of work that the client device 112 can place on the email server 206 within a rolling time window. For example, the request budget for the client device 112 can provide that the client device 112 cannot place more than thirty seconds worth of work on the email server 206 in any one minute time span. If the client device 112 has not exceeded its request budget, the workload manager 204 forwards the mailbox search request to the email server 206. If the client device 112 has exceeded its request budget, the workload manager 204 stores the mailbox search request in the request cache 208. When the client device 112 again has room in its request budget, the workload manager 204 removes the mailbox search request from the request cache 208 and forwards the mailbox search request to the email server 206. The client device 112 has room again in its request budget when enough time has passed such that the client device 112 has not placed more than the limit of work on the email server 206 within the rolling time window.

When the email server 206 receives a mailbox search request specifying a given mailbox, the email server 206 queries the email database 210 to identify email messages in the given mailbox that are relevant to one or more item counts. After identifying the email messages, the email server 206 counts the identified email messages to generate the given mailbox's item counts. For example, the mailbox search request can specify a query having the following keyword string: “patent AND (lawsuit OR litigation).” In this example, email messages associated with the keyword “lawsuit” are relevant to a first item count. Furthermore, in this example, the given target mailbox can contain fifty email messages associated with the keyword “lawsuit.” These fifty email messages may or may not be associated with the keywords “litigation” and “patent.” Hence, in this example, the first item count indicates that there are fifty relevant email messages in the given mailbox. In another example, the mailbox search request can specify a query having the following keyword string: “patent AND (lawsuit OR litigation).” In this example, email messages that satisfy the keyword string are relevant to a second item count. Furthermore, in this example, the given mailbox can contain twenty email messages associated with the keyword “patent” and also associated with either the keyword “lawsuit” or the keyword “litigation.” Hence, in this example, the second item count indicates that there are twenty relevant email messages in the given mailbox.

After generating the given mailbox's item counts, the email server 206 sends a mailbox search response to the web API server 202. The mailbox search response comprises the given mailbox's item counts.

As the web API server 202 receives mailbox search responses from the email server 206, the web API server 202 generates item counts for query by summing the individual target mailboxes' item counts. The web API server 202 then generates a single statistics response message 214 and sends the statistics response message 214 to the client access server 200. The statistics response message 214 specifies the item counts for the query. The client access server 200 uses the statistics response message 214 to generate web page data. The web page data represents a keyword statistics review page that specifies the item counts for the query. The client access server 200 then sends the web page data to the client device 112.

In various embodiments, the statistics response message 214 is formatted in various ways. For example, the statistics response message 214 can be formatted as a SOAP response. In this example, the statistics response message 214 can comprise a “FindMailboxStatisticsByKeywordsResponseMessageType” element that conforms to the following schema:

<xs:complexType
name=“FindMailboxStatisticsByKeywordsResponseMessageType”>

<xs:annotation>

<xs:documentation>

Response message type for the
FindMailboxStatisticsByKeywords web method.

</xs:documentation>

</xs:annotation>
<xs:complexContent>

<xs:extension base=“m:ResponseMessageType”>

<xs:sequence>

<xs:element name=“MailboxStatisticsSearchResult”

type=“t:MailboxStatisticsSearchResultType”/>

</xs:sequence>

</xs:extension>

</xs:complexContent>

</xs:complexType>

In this example, the “FindMailboxStatisticsByKeywordsResponseMessageType” element comprises a “MailboxStatisticsSearchResult” element belonging to the “MailboxStatisticsSearchResultType” type. The “MailboxStatisticsSearchResult” element specifies the number of email messages in the target mailboxes relevant to the item counts.

In this example, elements of type “MailboxStatisticsSearchResultType” conform to the following schema:

<xs:complexType name=“MailboxStatisticsSearchResultType”>

<xs:annotation>

<xs:documentation>

Mailbox statistics search result.

</xs:documentation>

</xs:annotation>
<xs:sequence>

<xs:element name=“UserMailbox” type=“t:UserMailboxType”

minOccurs=“1” maxOccurs=“1”/>

<xs:element name=“KeywordStatisticsSearchResult”

type=“t:KeywordStatisticsSearchResultType”/>

</xs:sequence>

</xs:complexType>

Elements of type “KeywordStatisticsSearchResultType” can conform to the following schema:

<xs:complexType name=“KeywordStatisticsSearchResultType”>

<xs:annotation>

<xs:documentation>

Keyword statistics search result.

</xs:documentation>

</xs:annotation>
<xs:sequence>

<xs:element name=“Keyword” type=“xs:string” minOccurs =“1”
maxOccurs=“1”/>
<xs:element name=“ItemHits” type=“xs:int” minOccurs =“1”
maxOccurs=“1”/>
<xs:element name=“Size” type=“xs:long” minOccurs =“1”
maxOccurs=“1”/>

</xs:sequence>

</xs:complexType>

In this example, the “KeywordStatisticsSearchResultType” element comprises a “Keyword” element, an “ItemHits” element, and a “Size” element. The “Keyword” element specifies a keyword in the query's keyword string. The “ItemHits” element specifies how many email messages in the target mailboxes are associated with the keyword specified in the “Keyword” element. The “Size” element specifies the total size of email messages in the target mailboxes associated with the keyword in the “Keyword” element. In another example, the “Keyword” element can specify the query's keyword string. In this example, the “ItemHits” element specifies how many email messages satisfy the query and the “Size” element specifies the total size of email messages that satisfy the query.

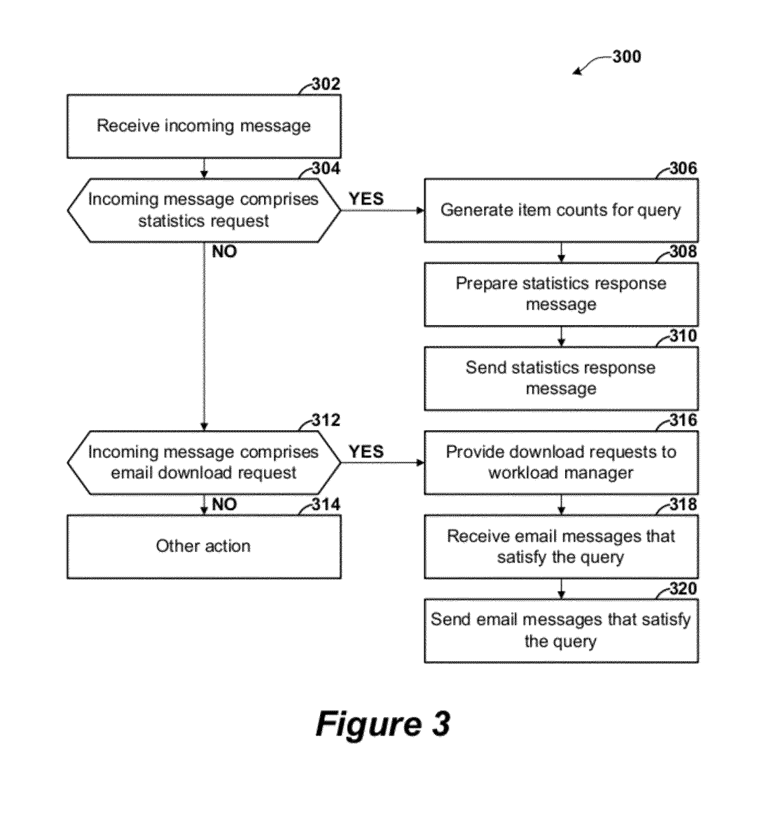

FIG. 3 is a flowchart illustrating an example operation 300 performed by the web API server 202. As illustrated in the example of FIG. 3, the operation 300 begins when the web API server 202 receives an incoming message from the client access server 200 (302). In various embodiments, the web API server 202 receives the incoming message from the client access server 200 in various ways. For example, the web API server 202 can receive the incoming message as a SOAP protocol message. In another example, the web API server 202 can receive the incoming message as a remote procedure call (RPC) message.

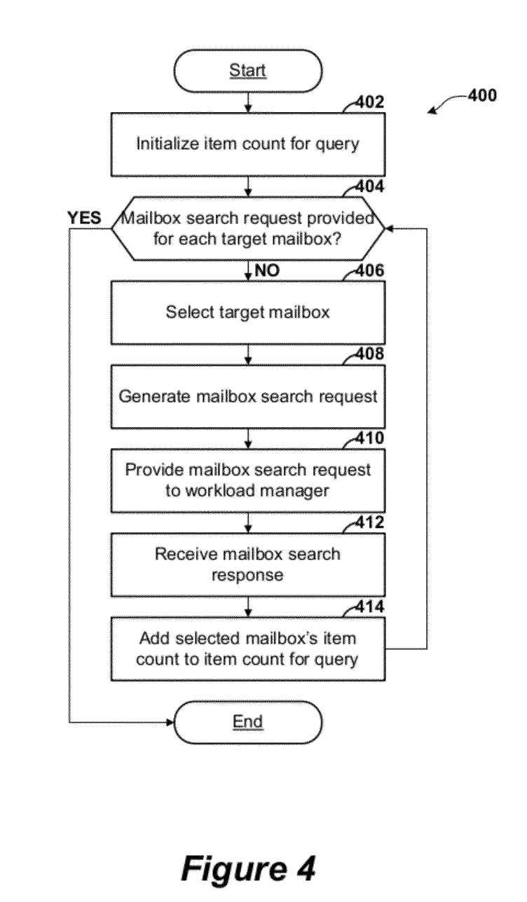

When the web API server 202 receives the incoming message, the web API server 202 determines whether the incoming message comprises a statistics request, such as the statistics request message 212 (304). As described above, a statistics request message includes a query that specifies a keyword string and a set of target mailboxes. If the incoming message comprises a statistics request (“YES” of 304), the web API server 202 generates one or more item counts for the query (306). This patent document describes an example operation to generate the item counts for the query with regard to FIG. 4.

After generating the item counts for the query, the web API server 202 prepares the statistics response message 214 (308). The statistics response message comprises keyword statistics data. The keyword statistics data indicates the item counts for the query. In various embodiments, the keyword statistics data is formatted in various ways. For example, the keyword statistics data can be formatted as a set of XML elements. In another example, the keyword statistics data can be formatted as a series of comma-separated values or name-value pairs. The statistics response message can conform to various communications protocols. For example, the statistics response message can conform to the SOAP protocol, the RPC protocol, the HTTP protocol, or another communications protocol. After preparing the outgoing message, the web API server 202 sends the statistics response message 214 to the client access server 200 (310).

If the incoming message does not comprise a statistics request (“NO” of 304), the web API server 202 determines whether the incoming message comprises an email download request (312). An email download request is a request to download email messages that satisfy a query. If the incoming message does not comprise an email download request (“NO” of 312), the web API server 202 can perform some other action or return an error (314).

If the incoming message comprises an email download request (“YES” of 312), the web API server 202 provides one or more download requests to the workload manager 204 (316). The download requests comprise requests for the email server 206 to identify the email messages that satisfy the query and send copies of the identified email messages to the web API server 202. In some embodiments, the web API server 202 provides a separate download request for each of the mailboxes specified by the query. The workload manager 204 forwards the download requests to the email server 206 as the request budget for the client device 112 allows.

After providing the download requests to the workload manager 204, the web API server 202 receives copies of email messages satisfying the query from the email server 206 (318). The web API server 202 then sends the copies of the email messages that satisfy the query to the client access server 200 (320).

FIG. 4 is a flowchart illustrating an example operation 400 performed by the web API server 202 to generate an item count for a query. As illustrated in the example of FIG. 4, the operation 400 begins when the web API server 202 initializes the item count for the query (402). For example, the web API server 202 can initialize the item count for the query to zero.

After initializing the item count for the query, the web API server 202 determines whether the web API server 202 has provided a mailbox search request for each of the query's target mailboxes (404). If the web API server 202 has not yet provided a mailbox search request for each of the query's target mailboxes (“NO” of 404), the web API server 202 selects one of the target mailboxes that has not yet been queried (406). The web API server 202 then generates a mailbox search request for the selected mailbox (408). The mailbox search request comprises the query's keyword string and a request for an item count. The web API server 202 then provides the mailbox search request to the workload manager 204 (410).

After the web API server 202 provides the mailbox search request to the workload manager 204, the web API server 202 receives a mailbox search response from the email server 206 (412). The mailbox search response specifies the selected mailbox's item count. In various embodiments, the email server 206 can generate the mailbox search response in various ways. For example, the email server 206 can generate a search folder in response to receiving the mailbox search request. The search folder includes a reference to each email message in the selected mailbox associated with any keyword in the query's keyword string. In this example, the email server 206 can reuse the search folder at a later time. For instance, the email server 206 can reuse the search folder to efficiently identify email messages to download to a client.

Upon receiving the mailbox search response, the web API server 202 adds the selected mailbox's item count to the item count for the query (414). The web API server 202 then loops back and determines again whether the web API server 202 has provided a mailbox search request for each of the query's target mailboxes (404). If the web API server 202 has provided mailbox search requests for each of the query's target mailboxes (“YES” of 404), the operation 400 is complete.

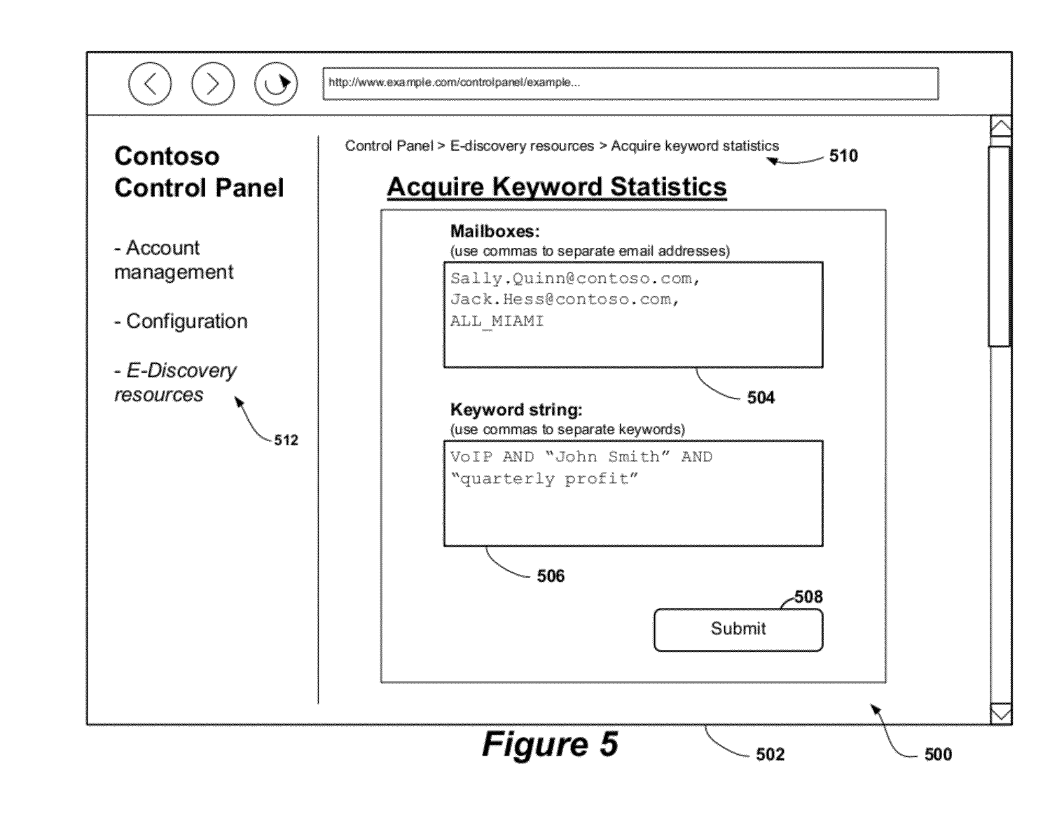

FIG. 5 is an example screen illustration of a keyword statistics request page 500 displayed by the client device 112. The keyword statistics request page 500 is displayed within a browser window 502. The browser window 502 is associated with a web browser application running on the client device 112.

As illustrated in the example of FIG. 5, the keyword statistics request page 500 comprises a mailbox selection control 504. The searcher 108 uses the mailbox selection control 504 to select a query's target mailboxes. In the example of FIG. 5, the mailbox selection control 504 enables the searcher 108 to type in email addresses or email distribution lists associated with the target mailboxes. For instance, in the example of FIG. 5, the searcher 108 has entered the email addresses “Sally.Quinn@contoso.com” and “Jack.Hess@contoso.com” in the mailbox selection control 504 along with the email distribution list “ALL_MIAMI.” Entering the name of an email distribution list can be a shorthand way of entering the email addresses in the email distribution list.

Furthermore, the keyword statistics request page 500 comprises a keyword selection control 506. The searcher 108 is able to use the keyword selection control 506 to select the query's keyword string. In the example of FIG. 5, the keyword selection control 506 enables the searcher 108 to type the keyword string into the keyword selection control 506. As illustrated in the example of FIG. 5, the searcher 108 has entered the keyword string “VoIP AND ‘John Smith’ AND ‘quarterly profit’” into the keyword selection control 506.

It should be appreciated that in other embodiments, the keyword statistics request page 500 can comprise other features that enable the searcher 108 to select target mailboxes or keyword strings. For example, the keyword statistics request page 500 can comprise drop boxes, radio buttons, selectable text blocks, or other elements that enable the searcher 108 to specify target mailboxes or keyword strings.

The keyword statistics request page 500 also comprises a submit control 508. When the searcher 108 selects the submit control 508, the client device 112 sends a form submission request to the client access server 200. The form submission request comprises a request to retrieve a keyword statistics response page. The form submission request also specifies the email addresses entered in the mailbox selection control 504 and the keyword string entered in the keyword selection control 506.

In some embodiments, the client device 112 performs an input validation routine when the searcher 108 selects the submit control 508. The input validation routine verifies that the searcher 108 has specified at least one target mailbox and a keyword string. If the searcher 108 has not specified at least one target mailbox and/or has not specified a keyword string, the input validation routine can cause the client device 112 to display a message alerting the searcher 108 that the searcher 108 has not specified at least one target mailbox and/or has not specified a keyword string.

In addition, the keyword statistics request page 500 can comprise other features such as navigation breadcrumbs 510 and navigation links 512. The navigation breadcrumbs 510 and the navigation links 512 can help the searcher 108 navigate among web pages in the control panel.

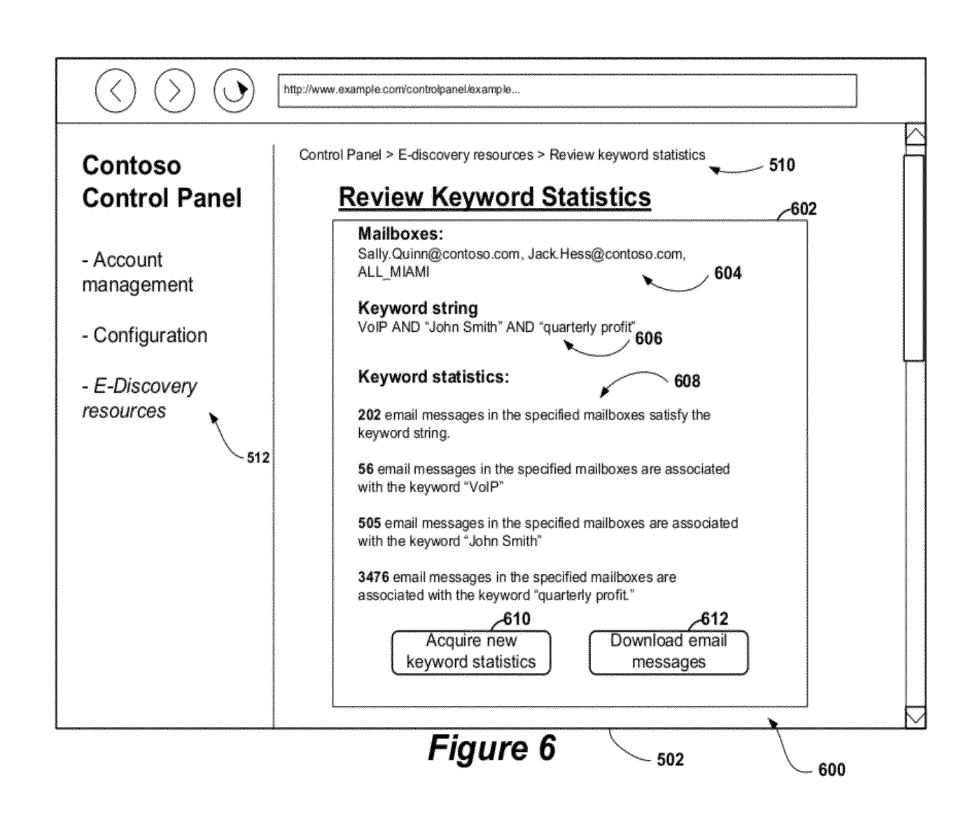

FIG. 6 is an example screen illustration of a keyword statistics review page 600 displayed by the client device 112. As illustrated in the example of FIG. 6, the keyword statistics review page 600 is displayed within the browser window 502. Like the keyword statistics request page 500, the keyword statistics review page 600 comprises the navigation breadcrumbs 510 and the navigation links 512. Inclusion of the navigation breadcrumbs 510 and the navigation links 512 in the keyword statistics review page 600 can help provide a consistent look and feel between the keyword statistics request page 500 and the keyword statistics review page 600.

The keyword statistics review page 600 includes a statistics area 602. The statistics area 602 comprises a mailbox list 604 that lists email addresses associated with the query's target mailboxes. The statistics area 602 also includes a keyword string element 606 that specifies the query's keyword string. Furthermore, the statistics area 602 includes a keyword statistics element 608 that specifies an item count for the query. In the example of FIG. 6, the keyword statistics element 608 is an item count that indicates that there are 202 relevant email messages in the target mailboxes that satisfy the keyword string. The keyword statistics element 608 also includes an item count that indicates that there are 56 email messages in the target mailboxes that are associated with the keyword “VoIP.” The keyword statistics element 608 also includes an item count that indicates that there are 505 email messages in the target mailboxes that are associated with the keyword “John Smith.” The keyword statistics element 608 also includes an item count that indicates that there are 3476 email messages in the target mailboxes that are associated with the keyword “quarterly profit.”

Furthermore, the review keyword statistics area 602 includes a new statistics control 610. Selection of the new statistics control 610 navigates the browser window 502 back to the keyword statistics request page 500. In addition, the review keyword statistics area 602 includes a download control 612. Selection of the download control 612 causes the client device 112 to send an email download request to the client access server 200. In response to the email download request, the client access server 200 transmits copies of the email messages satisfying the query to the client device 112 or another computing device.

FIG. 7 is a block diagram illustrating an example computing device 700. A computing device is a physical device capable of processing information to produce a desired result. In some embodiments, the server system 102, the client device 110, and the client device 112 are implemented using one or more computing devices like the computing device 700. It should be appreciated that in other embodiments, the server system 102, the client device 110, and the client device 112 are implemented using computing devices having hardware components other than those illustrated in the example of FIG. 7.

The term computer readable media as used herein may include computer storage media and communication media. As used in this document, a computer storage medium is a device or article of manufacture that stores data and/or software instructions executable by a computing device. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In the example of FIG. 7, the computing device 700 comprises a memory 702, a processing system 704, a secondary storage device 706, a network interface card 708, a video interface 710, a display unit 712, an external component interface 714, and a communication medium 716. The memory 702 includes one or more computer storage media capable of storing data and/or instructions. In different embodiments, the memory 702 is implemented in different ways. For example, the memory 702 can be implemented using various types of computer storage media.

The processing system 704 includes one or more processing units. A processing unit is a physical device or article of manufacture comprising one or more integrated circuits that selectively execute software instructions. In various embodiments, the processing system 704 is implemented in various ways. For example, the processing system 704 can be implemented as one or more processing cores. In another example, the processing system 704 can comprise one or more separate microprocessors. In yet another example embodiment, the processing system 704 can comprise an ASIC that provides specific functionality. In yet another example, the processing system 704 provides specific functionality by using an ASIC and by executing computer-executable instructions.

The secondary storage device 706 includes one or more computer storage media. The secondary storage device 706 stores data and software instructions not directly accessible by the processing system 704. In other words, the processing system 704 performs an I/O operation to retrieve data and/or software instructions from the secondary storage device 706. In various embodiments, the secondary storage device 706 comprises various types of computer storage media. For example, the secondary storage device 706 can comprise one or more magnetic disks, magnetic tape drives, optical discs, solid state memory devices, and/or other types of computer storage media.

The network interface card 708 enables the computing device 700 to send data to and receive data from a communication network. In different embodiments, the network interface card 708 is implemented in different ways. For example, the network interface card 708 can be implemented as an Ethernet interface, a token-ring network interface, a fiber optic network interface, a wireless network interface (e.g., WiFi, WiMax, etc.), or another type of network interface.

The video interface 710 enables the computing device 700 to output video information to the display unit 712. The display unit 712 can be various types of devices for displaying video information, such as a cathode-ray tube display, an LCD display panel, a plasma screen display panel, a touch-sensitive display panel, an LED screen, or a projector. The video interface 710 can communicate with the display unit 712 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 714 enables the computing device 700 to communicate with external devices. For example, the external component interface 714 can be a USB interface, a FireWire interface, a serial port interface, a parallel port interface, a PS/2 interface, and/or another type of interface that enables the computing device 700 to communicate with external devices. In various embodiments, the external component interface 714 enables the computing device 700 to communicate with various external components, such as external storage devices, input devices, speakers, modems, media player docks, other computing devices, scanners, digital cameras, and fingerprint readers.

The communications medium 716 facilitates communication among the hardware components of the computing device 700. In the example of FIG. 7, the communications medium 716 facilitates communication among the memory 702, the processing system 704, the secondary storage device 706, the network interface card 708, the video interface 710, and the external component interface 714. The communications medium 716 can be implemented in various ways. For example, the communications medium 716 can comprise a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 702 stores various types of data and/or software instructions. For instance, in the example of FIG. 7, the memory 702 stores a Basic Input/Output System (BIOS) 718 and an operating system 720. The BIOS 718 includes a set of computer-executable instructions that, when executed by the processing system 704, cause the computing device 700 to boot up. The operating system 720 includes a set of computer-executable instructions that, when executed by the processing system 704, cause the computing device 700 to provide an operating system that coordinates the activities and sharing of resources of the computing device 700. Furthermore, the memory 702 stores application software 722. The application software 722 comprises computer-executable instructions, that when executed by the processing system 704, cause the computing device 700 to provide one or more applications. The memory 702 also stores program data 724. The program data 724 is data used by programs that execute on the computing device 700.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can include the steps of the operations shown in the figures in different orders.

What is claimed is:

1. A method comprising:
receiving, at a web API server provided by a computing device, a statistics request from a client, the statistics request being a request to invoke an item counting method defined in an API provided by the web API server, the statistics request specifying a keyword string and multiple target data repositories, the keyword string comprising one or more keywords; and
sending a statistics response to the client as a response to the statistics request, the statistics response specifying an item count, the item count indicating how many relevant items are in the target data repositories, each of the relevant items associated with at least one of the keywords in the keyword string.

2. The method of claim 1, wherein each of the relevant items is associated with the same one of the keywords in the keyword string.

3. The method of claim 1, wherein each of the relevant items satisfies the keyword string.

4. The method of claim 1, further comprising:
receiving, by the web API server, a download request from the client; and
sending, by the web API server, copies of the relevant items to the client in response to the download request.

5. The method of claim 1,
wherein the method further comprises sending, by the web API server, multiple mailbox query requests to an email server, each of the mailbox query requests requesting counts of relevant items in different ones of the target data repositories;
wherein each of the target data repositories is a mailbox; and
wherein the relevant items are email messages.

6. The method of claim 1, wherein each of the target data repositories contains items of a tenant of a hosting provider.

7. The method of claim 1,
wherein the statistics request specifies a scope parameter; and
wherein each of the relevant items additionally satisfies the scope parameter.

8. The method of claim 1, wherein the statistics request is a SOAP request and the statistics response is a SOAP response.

9. A server system comprising:
one or more computing devices, at least one of the computing devices providing a client access server that:
sends a statistics request to a web API server, the statistics request requesting invocation of a item counting method defined by an API provided by the web API server, the statistics request specifying a keyword string and multiple target mailboxes, the keyword string comprising one or more keywords; and
receives a statistics response from the web API server as a response to the statistics request, the statistics response specifying an item count, the item count indicating how many relevant email messages are in the target mailboxes, each of the relevant email messages satisfying the keyword string.

10. The server system of claim 9,
wherein the client access server sends the statistics request to the web API server in response to a search request received from a client device, the search request specifying the keyword string and the target mailboxes; and
wherein the client access server does not send a request other than the statistics request to the web API server in response to the search request.

11. The server system of claim 10, wherein the client access server sends first web page data to the client device, the first web page data representing a keyword statistics request page, the keyword statistics request page including features for specifying the keyword string and the target mailboxes.

12. The server system of claim 11, wherein the client access server sends second web page data to the client device in response to receiving the search request, the second web page data representing a keyword statistics review page, the keyword statistics review page specifying the item count.

13. The server system of claim 12, wherein the client access server hosts a control panel website that enables a tenant to perform administration tasks with regard to a hosted email service that receives and sends email messages of the tenant, the control panel website including the keyword statistics request page and the keyword statistics review page.

14. The server system of claim 13,
wherein the server system comprises one or more computing devices that provide the hosted email service to the tenant; and
wherein each of the target mailboxes stores email messages of the tenant.

15. The server system of claim 13, wherein the server system is not located at a premises of the tenant.

16. The server system of claim 9,
wherein the item count is a first item count;
wherein the statistics response specifies additional item counts, the additional item counts indicating how many email messages in the target mailboxes are associated with individual ones of the keywords in the keyword string.

17. The server system of claim 9, wherein the statistics response specifies a total size of the relevant email messages.

18. The server system of claim 9,
wherein the client access server receives a scope parameter from a client; and
wherein each of the relevant email messages satisfies the scope parameter in addition to satisfying the keyword string.

19. The server system of claim 9, wherein the statistics request is a SOAP request.

20. A computer storage medium that stores computer-executable instructions that, when executed by a processing unit of a computing device, cause the computing device to provide a client access server that:
hosts a control panel website that enables a tenant to perform administration tasks with regard to a hosted email service that receives and sends email messages of the tenant, the hosted email service providing multiple mailboxes for the tenant, the hosted email service provided by a server system located a premises of a hosting provider, the control panel website including a keyword statistics request page and a keyword statistics review page;
sends first web page data to a client device, the first web page data representing the keyword statistics request page, the keyword statistics request page including features for specifying a keyword string and two or more target mailboxes, the target mailboxes being among the mailboxes for the tenant, the keyword string comprising one or more keywords;
sends a statistics request to a web API server in response to a search request received from the client device, the search request specifying the keyword string and the target mailboxes, the statistics request requesting invocation of a item counting method defined by an API provided by the web API server, the statistics request specifying the keyword string and the target mailboxes, wherein the client access server does not send a request other than the statistics request to the web API server in response to the search request;
receives a statistics response from the web API server as a response to the statistics request, the statistics response specifying a first item count and a second item count, the first item count indicating how many email messages in the target mailboxes satisfy the keyword string, the second item count specifying how many email messages in the target mailboxes specify an individual one of the keywords in the keyword string; and
sends second web page data to the client device as a response to the search request, the second web page data representing the keyword statistics review page, the keyword statistics review page specifying the first item count and the second item count.
